(19) United States
(12) Patent Application Publication
(10) Pub. No.: US 2026/0015088 A1
(43) Pub. Date: Jan. 15, 2026

(54) Aircraft portion comprising a cabin air circulation system

(71) Applicant: DASSAULT AVIATION, PARIS (FR)

(72) Inventors: Olivier CAPISTRAN, Little Rock, AR (US); Quentin DUGAS, Saint-Cloud (FR)

(21) Appl. No.: 19/263,890

(22) Filed: Jul. 9, 2025

(30) Foreign Application Priority Data
Jul. 12, 2024 (FR) FR 24 07666

(51) Int. Cl. B64D 13/06; B64C 1/40

(52) U.S. Cl. CPC B64D 13/06; B64C 1/40; B64D 2013/0688

(57) ABSTRACT

An aircraft portion including a cabin air circulation system, the aircraft portion including a fuselage, a partition wall, a first piece of furniture arranged against the fuselage in a first cabin portion and offset longitudinally from the partition wall, and an air circulation system between the first cabin portion and a second cabin portion. The air circulation system includes a first connection device in aeraulic communication with a first ambient air volume of the first cabin portion, a second connection device in aeraulic communication with a second ambient air volume of the second cabin portion, and an intermediate circuit. The first connection device is included in the first piece of furniture.

### TECHNICAL FIELD

The present disclosure relates to an aircraft portion comprising:
a fuselage delimiting a cabin extending according to a longitudinal axis, the cabin comprising a first cabin portion and a second cabin portion;
a partition wall mounted on the fuselage, extending substantially perpendicularly to the longitudinal axis and separating the first cabin portion and the second cabin portion;
at least one first piece of furniture arranged against the fuselage in the first cabin portion and offset longitudinally from the partition wall;
at least one air circulation system for air circulation between the first cabin portion and the second cabin portion, comprising:
at least one first connection device in aeraulic communication with a first ambient air volume of the first cabin portion, delimiting a first connection circuit;
at least one second connection device in aeraulic communication with a second ambient air volume of the second cabin portion, delimiting a second connection circuit; and
an intermediate circuit connecting the first connection device and the second connection device in aeraulic communication.

In such an aircraft portion, the air circulation system comprises, for example:
a first opening provided in the partition wall on the side of the first cabin portion;
a second opening provided in the partition wall on the side of the second cabin portion; and
a recess in the partition wall, aeraulically connecting the first and second openings.

Conventionally, the openings are, for example, covered with a grille in order to trim said openings, reduce the transport of particles, such as dust, and somewhat reduce the propagation of sounds.

### BACKGROUND

However, such an aircraft portion is not entirely satisfactory.

In particular, even if the openings are trimmed, they remain visible to passengers in the cabin. The aesthetic aspect of the partition wall is degraded.

Furthermore, the grilles are not sufficient to ensure good sound insulation between the cabin portions. Thus, passengers in one cabin portion may be disturbed by noise coming from the other cabin portion.

### SUMMARY

One goal of the present disclosure is to propose an aircraft portion that ensures air circulation in the cabin while improving the interior aesthetics of the cabin and ensuring satisfactory sound insulation.

To this end, the present disclosure has as object, an aircraft portion of the aforementioned type, in which the at least one first connection device is included in the at least one first piece of furniture.

By means of this feature, the interior aesthetics of the cabin is improved since the connection device is integrated into the first piece of furniture. Furthermore, integration of the connection device into the first piece of furniture improves sound insulation between the two cabin portions.

According to other advantageous aspects of the present disclosure, the aircraft portion comprises one or more of the following features, taken individually or according to any technically possible combination:
the fuselage comprises a lateral skirt extending according to the longitudinal axis between the first cabin portion and the second cabin portion, the at least one first piece of furniture being arranged against the lateral skirt, the lateral skirt delimiting at least partially the intermediate circuit;
the at least one first piece of furniture comprises at least one outer wall delimiting at least partially a first interior space of piece of furniture, the at least one outer wall further delimiting at least partially:
at least one air inlet opening of the first connection device aeraulically connecting the first connection circuit and the first ambient air volume of the first cabin portion; and
the first connection circuit;
the lateral skirt comprising at least one air inlet of the intermediate circuit extending facing the at least one first piece of furniture and being aeraulically connected to the first connection circuit;
the at least one air inlet opening of the first connection device is delimited by the at least one outer wall of the first piece of furniture and the lateral skirt of the fuselage;
the at least one outer wall of the first piece of furniture extends substantially according to a piece of furniture wall plane, the lateral skirt of the fuselage extending substantially according to a skirt plane intersecting the furniture wall plane according to an intersection line, the at least one air inlet opening being a slot extending between the at least one outer wall of the first piece of furniture and the lateral skirt of the fuselage along the intersection line;
the piece of furniture wall plane is substantially orthogonal to the longitudinal axis of the cabin;
the first connection device comprises a first deflector extending from the lateral skirt of the fuselage into the first interior space of piece of furniture facing the at least one air inlet opening, according to a first deflector plane extending substantially parallel to the piece of furniture wall plane, the first deflector of the first connection device and the at least one outer wall of the at least one first piece of furniture delimiting between them a first section of the first connection circuit;
the at least one first piece of furniture comprises at least one inner wall extending in the first interior space of piece of furniture substantially parallel to the first deflector so that the first deflector extends between the at least one outer wall and the at least one inner wall of the at least one first piece of furniture, the first deflector and the at least one inner wall of the at least one first piece of furniture delimiting between them a second section of the first connection circuit, the second section of the first connection circuit being aeraulically connected to the at least one air inlet of the intermediate circuit and to the first section of the first connection circuit;
the first connection device comprises a second deflector configured to guide the airflow circulating in the first section of the first connection circuit toward the second section of the first connection circuit and vice versa;
the surfaces of the first connection device and/or the at least one first piece of furniture delimiting the first connection circuit are at least partially covered by an acoustic insulation coating;
the aircraft portion further comprises at least one second piece of furniture arranged against the fuselage in the second cabin portion and offset longitudinally from the partition wall, the at least one second connection device being included in the at least one second piece of furniture;
the at least one second piece of furniture is arranged against the lateral skirt, the intermediate circuit extending according to the longitudinal axis between the at least one first connection device and the at least one second connection device.

### BRIEF SUMMARY OF THE DRAWINGS

The present disclosure will become clearer upon reading the following description, given solely by way of non-limiting example, and made with reference to the drawings in which:

FIG. 1 is a schematic perspective representation of an aircraft portion according to the present disclosure;

FIG. 2 is a schematic sectional representation of the aircraft portion of FIG. 1, according to the sectional plane II-II; and

FIG. 3 is a schematic sectional representation of the aircraft portion of FIG. 1, according to the sectional plane III-III.

### DETAILED DESCRIPTION

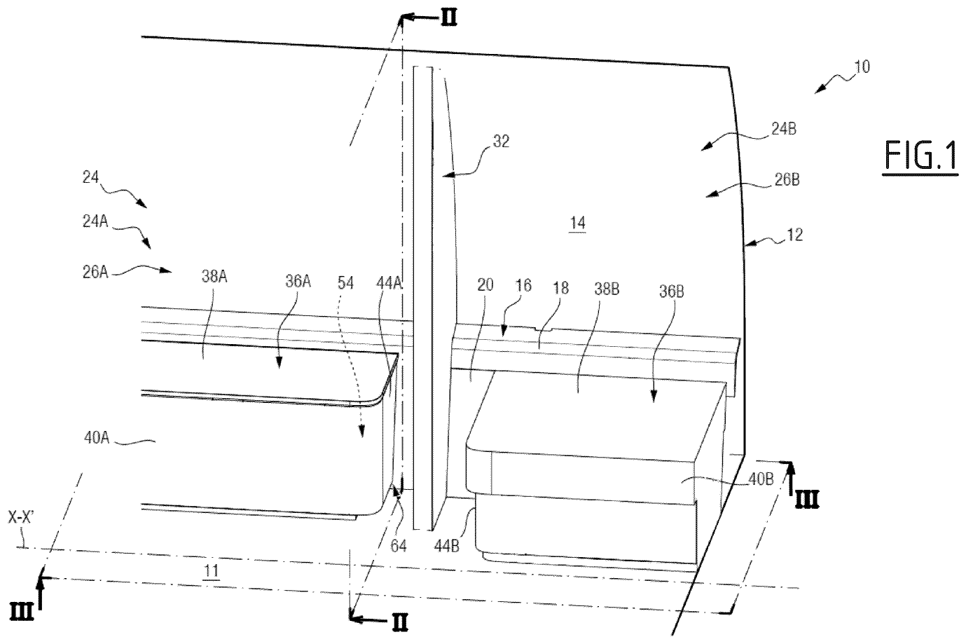

Referring to FIGS. 1 to 3, an aircraft portion 10 according to the present disclosure is described.

The aircraft portion 10 comprises a fuselage 12, a partition wall 32 mounted on the fuselage 12, at least one first piece of furniture 36A, and at least one air circulation system 54.

Advantageously, the aircraft portion 10 further comprises at least one second piece of furniture 36B.

Advantageously again, the aircraft portion 10 comprises a floor 11.

In the following, an example of the present disclosure is described in which the aircraft portion 10 comprises a single first piece of furniture 36A, a single air circulation system 54, and, if applicable, a single second piece of furniture 36B. Of course, the present disclosure also applies in cases where the aircraft portion 10 comprises a plurality of first pieces of furniture 36A, a plurality of air circulation systems 54, and/or a plurality of second pieces of furniture 36B.

Furthermore, in the following, an example of the present disclosure is described in which the air circulation is carried out from a first cabin portion 24A toward a second cabin portion 24B. The expressions “air inlet” and “air outlet” thus reflect this direction of circulation. Of course, the present disclosure also applies in the case where the air circulation is carried out from the second cabin portion 24B toward the first cabin portion 24A. In this case, the skilled person will understand that the “air inlets” mentioned below become “air outlets” and vice versa.

The fuselage 12 delimits a cabin 24 extending according to a longitudinal axis X-X′. The longitudinal axis X-X′ is notably substantially parallel to the roll axis of the aircraft.

For example, the fuselage 12 comprises a lateral wall 14 and a lateral skirt 16 extending according to the longitudinal axis X-X′ between a first cabin portion 24A and a second cabin portion 24B. In particular, the lateral skirt 16 extends from the lateral wall 14 of the fuselage 12 in the direction of the floor 11.

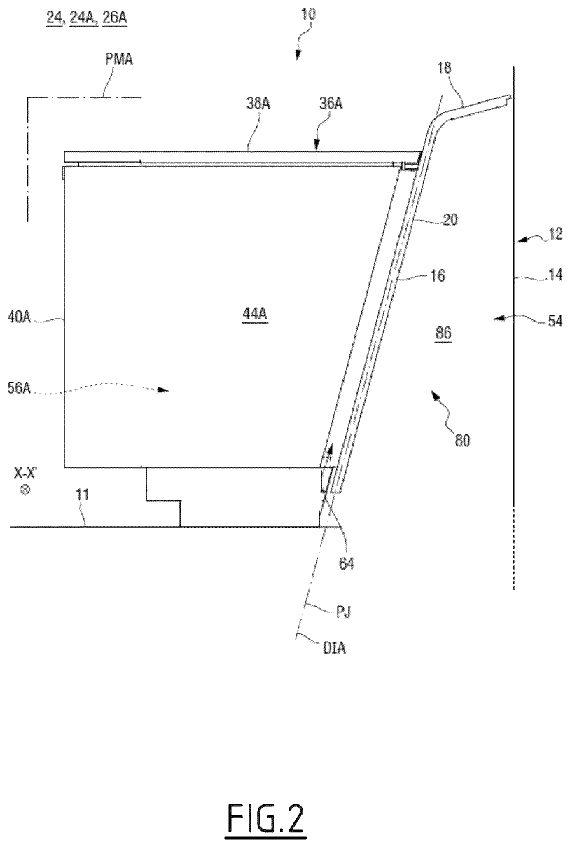

Notably, with reference to FIG. 2, the lateral skirt 16 extends according to a skirt plane PJ. For example, the skirt plane PJ is inclined relative to a median longitudinal plane of the fuselage 12.

For example, the lateral skirt 16 comprises an upper portion 18 fixed to the lateral wall 14 of the fuselage 12 and a substantially flat lower portion 20 extending from the upper portion 18. In particular, the lower portion 20 extends according to the skirt plane PJ.

Advantageously, the lateral skirt 16 at least partially delimits an intermediate circuit 80 of the air circulation system 54.

Advantageously again, the lateral skirt 16 comprises at least one air inlet 82 of the intermediate circuit 80, extending relative to the first piece of furniture 36A and being aeraulically connected to a first connection circuit 58A of a first connection device 56A of the air circulation system 54.

Advantageously again, the lateral skirt 16 comprises at least one air outlet 84 of the intermediate circuit 80 extending relative to the second piece of furniture 36B and being aeraulically connected to a second connection circuit 58B of a second connection device 56B of the air circulation system 54.

The cabin 24 is delimited between the floor 11 and the fuselage 12.

The cabin 24 comprises the first cabin portion 24A and the second cabin portion 24B.

The first cabin portion 24A delimits a first ambient air volume 26A.

The second cabin portion 24B delimits a second ambient air volume 26B.

The partition wall 32 extends substantially perpendicular to the longitudinal axis X-X′ and separates the first cabin portion 24A and the second cabin portion 24B.

Notably, the partition wall 32 is devoid of any air circulation device between the first cabin portion 24A and the second cabin portion 24B. In particular, the partition wall 32 is devoid of air circulation openings intended to allow air circulation between the first cabin portion 24A and the second cabin portion 24B, notably when a door connecting the first cabin portion 24A and the second cabin portion 24B through the partition wall 32 is closed. By “air circulation openings” is meant openings made in the partition wall 32 and specifically designed for air circulation, such as, for example, air vents. Openings intended for other functions, as for example, for the passage of electrical cables or others, are not considered as air circulation openings.

The first piece of furniture 36A is arranged against the fuselage 12, in particular against the lateral skirt 16, notably against the lower portion 18 of the lateral skirt 16, in the first cabin portion 24A.

For example, the first piece of furniture 36A is a set of drawers, a sofa, a table, a bed, or any other furniture traditionally installed in an aircraft cabin.

The first piece of furniture 36A is offset longitudinally from the partition wall 32. In other words, the first piece of furniture 36A and the partition wall 32 are separated according to the longitudinal axis X-X′ by a non-zero separation distance. Advantageously, the separation distance between the first piece of furniture 36A and the partition wall 32 is greater than or equal to 1 cm.

Advantageously, the first piece of furniture 36A comprises at least one outer wall at least partially delimiting a first interior space of the furniture 50A.

According to the example illustrated in FIGS. 1 to 3, the first piece of furniture 36A comprises:
an upper outer wall 38A extending substantially parallel to the floor 11;
a front outer wall 40A extending substantially perpendicular to the upper outer wall 38A from the upper outer wall 38A toward the floor 11;
a rear outer wall 42A extending substantially parallel to the skirt plane PJ from the upper outer wall 38A toward the floor 11; and
lateral outer walls 44A extending substantially perpendicular to the upper 38A, front 40A, and rear 42A outer walls (only one lateral outer wall 44A is visible in FIGS. 1 to 3).

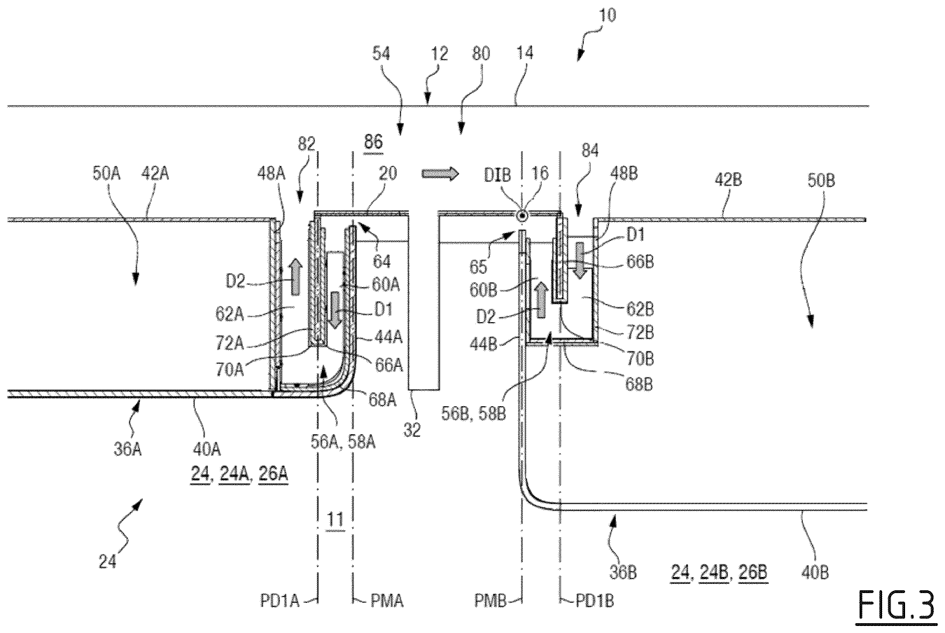

Advantageously again, with reference to FIG. 3, the first piece of furniture 36A further comprises at least one inner wall 48A.

The at least one outer wall, notably in the example of FIGS. 1 to 3, one or both lateral outer walls 44A, further delimits at least partially:
at least one air inlet opening 64 of the first connection device 56A, aeraulically connecting the first connection circuit 58A and the first ambient air volume 26A; and
the first connection circuit 58A.

For example, the at least one outer wall, notably the lateral outer wall 44A, extends substantially according to a first furniture wall plane PMA.

Notably, the piece of furniture wall plane PMA is substantially orthogonal to the longitudinal axis X-X′ of the cabin 24.

As will be described in more detail below, the at least one outer wall, notably the lateral outer wall 44A, delimits with a first deflector 66A of the first connection device 56A a first section 60A of the first connection circuit 58A.

With reference to FIG. 3, the at least one inner wall 48A extends in the first interior space of the furniture 50A. In particular, the at least one inner wall 48A extends from the front outer wall 40A to the rear outer wall 42A of the first piece of furniture 36A.

Notably, the at least one inner wall 48A extends substantially parallel to the first deflector 66A. For example, the at least one inner wall 48A extends substantially parallel to the first furniture wall plane PMA.

As will be described in more detail below, the at least one inner wall 48A delimits with the first deflector 66A of the first connection device 56A a second section 62A of the first connection circuit 58A.

The second piece of furniture 36B is arranged against the fuselage 12, in particular, against the lateral skirt 16, in the second cabin portion 24B.

For example, the second piece of furniture 36B is a set of drawers, a sofa, a table, a bed, or any other furniture traditionally installed in an aircraft cabin.

The second piece of furniture 36B is offset longitudinally from the partition wall 32. In other words, the second piece of furniture 36B and the partition wall 32 are separated according to the longitudinal axis X-X′ by a non-zero separation distance. Advantageously, the separation distance between the second piece of furniture 36B and the partition wall 32 is greater than or equal to 1 cm.

Advantageously, the second piece of furniture 36B comprises at least one outer wall at least partially delimiting a second interior space of piece of furniture 50B.

According to the example illustrated in FIGS. 1 and 3, the second piece of furniture 36B comprises:
an upper outer wall 38B extending substantially parallel to the floor 11;
a front outer wall 40B extending substantially perpendicular to the upper outer wall 38B from the upper outer wall 38B toward the floor 11;
a rear outer wall 42B extending substantially parallel to the skirt plane PJ from the upper outer wall 38B toward the floor 11; and
lateral outer walls 44B extending substantially perpendicular to the upper 38B, front 40B, and rear 42B outer walls (only one lateral outer wall 44B is visible in FIGS. 1 and 3).

Advantageously again, with reference to FIG. 3, the second piece of furniture 36B further comprises at least one inner wall 48B.

The at least one outer wall, notably in the example of FIGS. 1 and 3, one or both lateral outer walls 44B, further at least partially delimits:
at least one air outlet opening 65 of the second connection device 56B, aeraulically connecting the second connection circuit 58B and the second ambient air volume 26B; and
the second connection circuit 58B.

For example, the at least one outer wall, notably the lateral outer wall 44B, extends substantially according to a second furniture wall plane PMB.

Notably, the second furniture wall plane PMB is substantially orthogonal to the longitudinal axis X-X′ of the cabin 24.

As will be described in more detail below, the at least one outer wall, notably the lateral outer wall 44B, delimits with a first deflector 66B of the second connection device 56B a first section 60B of the second connection circuit 58B.

With reference to FIG. 3, the at least one inner wall 48B extends in the second interior space of the furniture 50B. In particular, the at least one inner wall 48B extends from the front outer wall 40B to the rear outer wall 42B.

Notably, the at least one inner wall 48B extends substantially parallel to the first deflector 66B. For example, the at least one inner wall 48B extends substantially parallel to the second furniture wall plane PMB.

As will be described in more detail below, the at least one inner wall 48B delimits with the first deflector 66B of the second connection device 56B a second section 62B of the second connection circuit 58B.

The system 54 is an air circulation system between the first cabin portion 24A and the second cabin portion 24B.

The air circulation system 54 comprises the at least one first connection device 56A, the at least one second connection device 56B, and the intermediate circuit 80.

In the following, only one first connection device 56A and one second connection device 56B are described. Of course, the description also applies to several first connection devices 56A and/or several second connection devices 56B.

Advantageously, the air circulation system 54 further comprises an air circulation device (not illustrated) configured to circulate air from the at least one first connection device 56A toward the at least one second connection device 56B by means of the intermediate circuit 80, or vice versa. The at least one air circulation device comprises, for example, at least one fan.

The first connection device 56A is in aeraulic communication with the first ambient air volume 26A of the first cabin portion 24A.

In particular, the first connection device 56A opens into the first ambient air volume 26A of the first cabin portion 24A.

The first connection device 56A delimits the first connection circuit 58.

The first connection device 56A is included in the first piece of furniture 36A.

The first connection device 56A comprises the at least one air inlet opening 64.

Advantageously, the first connection device 56A further comprises the first deflector 66A (visible in FIG. 3).

Advantageously again, the first connection device 56A further comprises a second deflector 68A (visible in FIG. 3).

As illustrated in FIGS. 2 and 3, the at least one air inlet opening 64 is delimited by the at least one outer wall of the first piece of furniture 36A, notably the lateral outer wall 44A, and the lateral skirt 16 of the fuselage 12, notably the lower portion 20 of the lateral skirt 16.

As visible in FIG. 2, the at least one air inlet opening 64 is a slot extending between the at least one outer wall of the first piece of furniture 36A, notably the lateral outer wall 44A, and the lateral skirt 16 of the fuselage 12, notably the lower portion 20 of the lateral skirt 16, along a first intersection line DIA. The first intersection line DIA is defined by the intersection between the skirt plane PJ and the first furniture wall plane PMA.

For example, the at least one air inlet opening 64 opens into the first ambient air volume 26A of the first cabin portion 24A.

With reference to the example of FIG. 3, the first deflector 66A extends from the lateral skirt 16 of the fuselage 12 into the first interior space of the furniture 50A facing the at least one air inlet opening 64, according to a first deflector plane PD1A extending substantially parallel to the first furniture wall plane PMA.

The first deflector 66A and the at least one outer wall, notably the lateral outer wall 44A, delimit between them the first section 60A of the first connection circuit 58A.

Advantageously, the first deflector 66A extends between the at least one outer wall, notably the lateral outer wall 44A, and the at least one inner wall 48A of the first piece of furniture 36A.

Notably, the first deflector 66A and the at least one inner wall 48A delimit between them the second section 62A of the first connection circuit 58A.

Advantageously, the second section 62A of the first connection circuit 58A is aeraulically connected to the at least one air inlet 82 of the intermediate circuit 80 and to the first section 60A of the first connection circuit 58A. In particular, the second section 62A aeraulically connects the first section 60A and the at least one air inlet 82 of the intermediate circuit 80.

The second deflector 68A is configured to guide the airflow circulating in the first section 60A toward the second section 62A and vice versa.

As illustrated in the example of FIG. 3, the first connection circuit 58A presents a general shape, according to a sectional plane substantially parallel to the floor 11, in the form of a chicane. To reach the air inlet 82 of the intermediate circuit 80, the air entering through the air inlet opening 64 into the first section 60A of the first connection circuit 58A must first bypass the first deflector 66A to enter into the second section 62A of the first connection circuit 58A.

Advantageously, as illustrated in FIG. 3, the surfaces 70A of the first connection device 56A and/or the first piece of furniture 36A, delimiting the first connection circuit 58A, are at least partially covered by an acoustic insulation coating 72A.

Notably, the surfaces of:
the at least one outer wall, notably the lateral outer wall 44A; and/or
the at least one inner wall 48A; and/or
the first deflector 66A; and/or
the second deflector 68A; and/or
delimiting the first and second sections 60A, 62A of the first connection circuit 58A are at least partially, in particular entirely, covered by the acoustic insulation coating 72A.

The second connection device 56B is in aeraulic communication with the second ambient air volume 26B of the second cabin portion 24B.

In particular, the second connection device 56B opens into the second ambient air volume 26B of the second cabin portion 24B.

The second connection device 56B delimits the second connection circuit 58B.

The second connection device 56B is included in the second piece of furniture 36B.

The second connection device 56B comprises the at least one air outlet opening 65.

Advantageously, the second connection device 66B further comprises the first deflector 66B (visible in FIG. 3).

Advantageously again, the second connection device 66B further comprises a second deflector 68B (visible in FIG. 3).

As illustrated in FIG. 3, the at least one air outlet opening 65 is delimited by the at least one outer wall of the second piece of furniture 36B, notably the lateral outer wall 44B, and the lateral skirt 16 of the fuselage 12, notably the lower portion 20 of the lateral skirt 16.

As visible in FIG. 3, the at least one air outlet opening 65 is a slot extending between the at least one outer wall of the second piece of furniture 36B, notably the lateral outer wall 44B, and the lateral skirt 16 of the fuselage 12, notably the lower portion 20 of the lateral skirt 16, along a second intersection line DIB. The intersection line DIB is defined by the intersection between the skirt plane PJ and the second furniture wall plane PMB.

For example, the at least one air outlet opening 65 opens into the second ambient air volume 26B of the second cabin portion 24B.

Referring to the example in FIG. 3, the first deflector 66B extends from the lateral skirt 16 of the fuselage 12 into the second interior space of piece of furniture 50B facing the at least one air outlet opening 65, according to a second first deflector plane PD1B extending substantially parallel to the second furniture wall plane PMB.

The first deflector 66B and the at least one outer wall of the second piece of furniture 36B delimit between them the first section 60B of the second connection circuit 58B.

Advantageously, the first deflector 66B extends between the at least one outer wall of the second piece of furniture 36B and the at least one inner wall 48B of the second piece of furniture 36B.

Notably, the first deflector 66B and the at least one inner wall 48B delimit between them the second section 62B of the second connection circuit 58B.

Advantageously, the second section 62B of the second connection circuit 58B is aeraulically connected to the at least one air outlet 84 of the intermediate circuit 80 and to the first section 60B of the second connection circuit 58B. In particular, the second section 62B aeraulically connects the first section 60B and the at least one air outlet 84 of the intermediate circuit 80.

The second deflector 68B is configured to guide the airflow circulating in the second section 62B toward the first section 60B and vice versa.

As illustrated in the example of FIG. 3, the second connection circuit 58B presents a general shape, according to a sectional plane substantially parallel to the floor 11, in the form of a chicane. To reach the air outlet opening 65 of the second connection device 56B, the air entering through the air outlet 84 of the intermediate circuit 80 into the second section 62B of the second connection circuit 58B must first bypass the first deflector 66B to enter into the first section 60B of the second connection circuit 58B.

Advantageously, as illustrated in FIG. 3, the surfaces 70B of the second connection device 56B and/or the second piece of furniture 36B, delimiting the second connection circuit 58B, are at least partially covered by an acoustic insulation coating 72B.

Notably, the surfaces of:
the at least one outer wall, notably the lateral outer wall 44B; and/or
the at least one inner wall 48B; and/or
the first deflector 66B; and/or
the second deflector 68B; and/or
delimiting the first and second sections 60B, 62B of the second connection circuit 58B are at least partially, in particular entirely, covered by the acoustic insulation coating 72B.

The intermediate circuit 80 aeraulically connects the first connection device 56A, in particular the first connection circuit 58A, and the second connection device 56B, in particular the second connection circuit 58B.

Advantageously, the intermediate circuit 80 extends according to the longitudinal axis X-X′ from the first connection device 56A to the second connection device 56B

The intermediate circuit 80 comprises the at least one air inlet 82, the at least one air outlet 84, and an air circulation passage 86 aeraulically connecting the at least one air inlet 82 and the at least one air outlet 84.

Referring to the example in FIG. 3, the air circulation passage 86 is delimited by the lateral skirt 16 and the lateral wall 14 of the fuselage 12 and extends according to the longitudinal axis X-X′ from the at least one air inlet 82 and the at least one air outlet 84.

The following describes the operation of the aircraft portion 10 such as described above.

For example, the air circulation device (not illustrated) circulates air from the first connection device 56A toward the second connection device through the intermediate circuit 80.

The air from the first ambient air volume 26A is then drawn through the air inlet opening 64A of the first connection device 56A. The drawn air then circulates in the first section 60A of the first connection circuit 58A according to a first general direction D1 then in the second section 62A of the first connection circuit 58A according to a second general direction D2 opposite to the first general direction D1 to reach the air inlet 82 of the intermediate circuit 80. The air then circulates in the air circulation passage 86 to the air outlet 84 of the intermediate circuit 80. The air then enters the second section 62B of the second connection circuit 58B, circulates in the second section 62B according to the first general direction D1, and is then conveyed into the first section 60B of the second connection circuit 58B according to the second general direction D2 to reach the air outlet opening 65 of the second connection device 56B. The air then enters via the air outlet opening 65 into the second cabin portion 24B to add to the second ambient air volume 26B.

Due to the present disclosure, the aesthetics of the first and second cabin portions 24A, 24B are improved since the connection devices are integrated respectively into the first piece of furniture 36A and the second piece of furniture 36B. Notably, the air inlet 64 and outlet 65 openings are discreet as they are arranged between the lateral skirt 16 and the lateral outer wall 44A, 44B of the piece of furniture and in the form of a slot. The present disclosure thus allows dispensing with any air circulation device mounted on the partition wall 32. The appearance of the partition wall 32 is improved.

This integration also improves sound insulation between the two cabin portions 24A, 24B. In particular, the specific shape of the first and second connection circuits 58A, 58B in chicanes increases sound insulation. The acoustic insulation coating further enhances this sound insulation.

What is claimed is:

1. An aircraft portion comprising:
a fuselage delimiting a cabin extending according to a longitudinal axis, the cabin comprising a first cabin portion and a second cabin portion;
a partition wall mounted on the fuselage, extending substantially perpendicular to the longitudinal axis and separating the first cabin portion and the second cabin portion;
at least one first piece of furniture arranged against the fuselage in the first cabin portion and offset longitudinally from the partition wall; and
at least one air circulation system for air circulation between the first cabin portion and the second cabin portion, the at least one air circulation system comprising:
at least one first connection device in aeraulic communication with a first ambient air volume of the first cabin portion, delimiting a first connection circuit;
at least one second connection device in aeraulic communication with a second ambient air volume of the second cabin portion, delimiting a second connection circuit; and
an intermediate circuit connecting the first connection device and the second connection device in aeraulic communication;
the at least one first connection device being included in the at least one first piece of furniture.

2. The aircraft portion according to claim 1, wherein the fuselage comprises a lateral skirt extending according to the longitudinal axis between the first cabin portion and the second cabin portion, the at least one first piece of furniture being arranged against the lateral skirt, the lateral skirt delimiting at least partially the intermediate circuit.

3. The aircraft portion according to claim 2, wherein the at least one first piece of furniture comprises at least one outer wall delimiting at least partially a first interior space of piece of furniture, the at least one outer wall further delimiting at least partially:
at least one air inlet opening of the first connection device aeraulically connecting the first connection circuit and the first ambient air volume of the first cabin portion; and
the first connection circuit,
the lateral skirt comprising at least one air inlet of the intermediate circuit extending facing the at least one first piece of furniture and being aeraulically connected to the first connection circuit.

4. The aircraft portion according to claim 3, wherein the at least one air inlet opening of the first connection device is delimited by the at least one outer wall of the first piece of furniture and the lateral skirt of the fuselage.

5. The aircraft portion according to claim 4, wherein the at least one outer wall of the first piece of furniture extends substantially according to a piece of furniture wall plane, the lateral skirt of the fuselage extending substantially according to a skirt plane intersecting the piece of furniture wall plane according to an intersection line, the at least one air inlet opening being a slot extending between the at least one outer wall of the first piece of furniture and the lateral skirt of the fuselage along the intersection line.

6. The aircraft portion according to claim 5, wherein the piece of furniture wall plane is substantially orthogonal to the longitudinal axis of the cabin.

7. The aircraft portion according to claim 5, wherein the first connection device comprises a first deflector extending from the lateral skirt of the fuselage into the first interior space of piece of furniture facing the at least one air inlet opening, according to a first deflector plane extending substantially parallel to the piece of furniture wall plane,
the first deflector of the first connection device and the at least one outer wall of the at least one first piece of furniture delimiting between them a first section of the first connection circuit.

8. The aircraft portion according to claim 7, wherein the at least one first piece of furniture comprises at least one inner wall extending in the first interior space of piece of furniture substantially parallel to the first deflector so that the first deflector extends between the at least one outer wall and the at least one inner wall of the at least one first piece of furniture,
the first deflector and the at least one inner wall of the at least one first piece of furniture delimiting between them a second section of the first connection circuit,
the second section of the first connection circuit being aeraulically connected to the at least one air inlet of the intermediate circuit and to the first section of the first connection circuit.

9. The aircraft portion according to claim 8, wherein the first connection device comprises a second deflector configured to guide an airflow circulating in the first section of the first connection circuit toward the second section of the first connection circuit and vice versa.

10. The aircraft portion according to claim 1, wherein surfaces of the first connection device and/or the at least one first piece of furniture delimiting the first connection circuit are at least partially covered by an acoustic insulation coating.

11. The aircraft portion according to claim 1, further comprising at least one second piece of furniture arranged against the fuselage in the second cabin portion and offset longitudinally from the partition wall,
the at least one second connection device being included in the at least one second piece of furniture.

12. The aircraft portion according to claim 11, wherein the fuselage comprises a lateral skirt extending according to the longitudinal axis between the first cabin portion and the second cabin portion, the at least one first piece of furniture being arranged against the lateral skirt, the lateral skirt delimiting at least partially the intermediate circuit and wherein the at least one second piece of furniture is arranged against the lateral skirt, the intermediate circuit extending according to the longitudinal axis between the at least one first connection device and the at least one second connection device.
